(19) United States
(12) Patent Application Publication
(10) Pub. No.: US 2026/0280380 A1
(43) Pub. Date: Sep. 17, 2026

(54) ELECTRIC MOTOR WITH VIBRATION DAMPING STRUCTURE

(71) Applicant: ABB Schweiz AG, Baden (CH)

(72) Inventor: Charles Konzelman, Fort Smith, AK (US)

(21) Appl. No.: 19/078,636

(22) Filed: Mar. 13, 2025

(51) Int. Cl. H02K 5/24; H02K 1/16; H02K 1/2706; H02K 5/02

(52) U.S. Cl. CPC H02K 5/24; H02K 1/16; H02K 1/2706; H02K 5/02

(57) ABSTRACT

The present disclosure is directed to improvements for an electric motor which reduce vibrations thereof. In particular, an electric motor body is constructed at least in part using a constrained layer damping structure. Additionally, a plug material is used to fill gaps within the electric motor body and respective components. Furthermore, a sealing layer is provided for use between rotor disks to decouple vibrations therebetween. Embodiments are provided which describe different examples of materials for use therein.

### TECHNICAL FIELD

The present disclosure generally relates to electric motors. More specifically the present disclosure relates to electric motors that include structure that provides damping to the motor and motor components.

### BACKGROUND

Electric motors are widely used to provide motive force to an associated system or device. Generally, electric motors convert electrical energy into motor output motion using magnets through induced magnetism. Most electric motors consist of two primary assemblies. These two primary assemblies comprise a rotor and a stator. The stator is comprised of a series of electromagnets arranged in an annular configuration to form a hollow cylinder that defines a cylinder chamber, having a central axis. The electromagnets are arranged such that a pole of each magnet is directed toward the central axis of the hollow cylinder. The rotor is comprised a series of electromagnets or permanent magnets arranged in a cylindrical configuration and mounted along a rotatable shaft. As assembled for use, the rotor is positioned within the cylinder chamber with the longitudinal axis of the shaft aligned with the central axis of the hollow cylinder. The electromagnets of the rotor are arranged so that a pole of each electromagnet is directed away from the housing central axis and toward the poles of the stator electromagnets. By selectively adjusting the polarity of either the stator or rotor electromagnets via an electric current, the resulting transient magnetic field will cause the rotor to rotate about the central axis.

In most industrial applications, energy is supplied to the motor via alternating current (AC). In an AC motor, the electromagnets are powered by the current, which oscillates over time. Each electromagnet creates an oscillating magnetic field which varies over time according to the alternating current. The result of the oscillating magnetic field is a transient magnetic field within the stator, which pulses or rotates according to the phase of the alternating current powering each electromagnet. The rotor, which comprises either electromagnets or permanent magnets as described above, is caused to rotate as the individual poles “chase” the transient magnetic field.

The rotor and stator are positioned in a casing with the shaft of the rotor protruding from one end of the casing and supported by a bearing. A mechanical load is connected to the shaft such that the rotating shaft transmits a torque to the mechanical load. The casing is often made of metal such as either an aluminum alloy, steel alloy, or cast iron and is mounted for use, in a location using a metal bracket. The casing may either be made as a unitary component with closed ends, or as a hollow cylinder closed with metal end caps.

When the electric motor is operating, the individual motor components vibrate. For example, single phase AC motors tend to vibrate more intensely than three-phase AC motors, as the pulsations of the magnetic field of the AC motor result in unsteady torque output. Generally, electromagnetic forces cause movement and vibration of components within the motor body. Additionally, minor manufacturing defects, such as a rotor with a center of mass slightly offset from the central axis of rotation, will cause the rotor to be imbalanced and rotate unevenly. Similarly, if the rotor is not concentric with the stator, the resulting imbalance can cause vibration. The resulting vibrations are transmitted through the shaft bearing and yield vibrational disturbances in both the rotor and the casing. Mechanical defects within the motor may also result in unbalanced electromagnetic loads. Furthermore, high revolution or high torque applications may result in the motor vibrating due to minor mechanical imperfections, misalignments, insufficient lubrication, for example.

A motor with no manufacturing defects will vibrate due to internal electromagnetic forces developed in normal operation. Manufacturing defects such as mechanical imbalance, bearing imperfections, rotor/stator static and dynamic eccentricities, and material non-homogeneities will lead to additional mechanical and electromagnetic excitation forces that act to increase vibration levels. Vibration levels typically worsen with increases in load and speed. Finally, interactions with driven equipment and the motor mounting structure and excitations from surrounding machinery can profoundly affect motor vibration.

The metal casing and bracket are also known to resonate as a result of vibratory conditions. In particular, the metal case may resonate at low frequency modes caused by unbalanced mechanical or electromagnetic loads. Furthermore, the vibration of individual components within the motor can combine and create significant global vibration of the motor body. Vibration of electric motors produces increased wear and tear of the motor, motor components, and motor mounting components. Unanticipated or unnoticed wear and tear may cause the motor to fail. Vibrations also produce undesirable noise during motor operation.

An electric motor is a structure and possesses a set of natural frequencies at which it will freely vibrate with decaying sinusoidal oscillations. Associated with each natural frequency is mode shape, or spatial pattern of vibration. Natural frequencies of interest for electric motors span a range of frequencies from several hertz to several kilohertz. Low frequency modes usually involve global motor motions and extended interactions between components, while mid to high-frequency modes involve more localized or highly localized motions in sub-assemblies or individual parts.

When a motor is exposed to internal or external time-varying forces, these modes of vibration will be excited to varying degrees. If a frequency component of the excitation forces coincides with (or nearly coincides with) a motor natural frequency, the associated mode shape can be excited to large vibration amplitudes if the mode is undamped or lightly damped. This phenomenon is called resonance. Low frequency resonances can lead to extreme vibration and eventually motor failure. Mid and high-frequency resonances lead to objectionable vibration levels and noise, although mid-frequency resonances can lead to motor failure if vibration levels are severe enough.

Accordingly, there exists a need to cure the deficiencies associated with electric motor vibrations. Specifically, there is a need to provide a solution which reduces vibrations to an acceptable level, reduces motor component wear and tear, and reduces noise to an acceptable level.

This section is intended to introduce the reader to various aspects of art that may be related to various aspects of the present disclosure described or claimed below. This description is believed to be helpful in providing the reader with background information to facilitate a better understanding of the various aspects of the present disclosure. Accordingly, it should be understood that these statements are to be read in this light and not as admissions of prior art.

### BRIEF DESCRIPTION

In one embodiment of the disclosure, an electric motor comprising a casing defining a casing chamber, the casing comprising a constrained layer damping structure; at least one casing end cap which is affixed to an end of the casing chamber, the at least one end cap comprising a constrained layer damping structure; a stator disposed within the casing chamber, the stator comprising an annular structure which defines a stator chamber, the annular structure comprising a plurality of current-carrying windings; and a rotor disposed in the stator chamber, the rotor comprising a number of rotor disks along a rotor shaft.

In another embodiment of the disclosure, an electric motor comprising a stator comprising a plurality of current-carrying windings; a rotor disposed proximate the stator, the rotor comprising at least two rotor disks mounted on a rotor shaft, each of the at least two rotor disks being adjacent at least one rotor disk, adjacent rotor disks defining a space, wherein a sealing layer is located in each space defined by adjacent disks, and wherein each of the at least two rotor disks comprising at least one magnet positioned adjacent at least one groove wall and defining at least one groove recess therebetween.

In another embodiment of the disclosure, an electric motor comprising a casing defining a casing chamber, the casing comprising a constrained layer damping structure; at least one casing end cap which is affixed to an end of the casing chamber, the at least one end cap comprising a constrained layer damping structure; a stator disposed within the casing chamber, the stator comprising an annular structure which defines a stator chamber, the annular structure comprising a plurality of current-carrying windings, wherein the annular structure of the stator and the casing chamber define a gap therebetween, wherein the gap is filled with an annular member which is co-axial with the stator chamber, and wherein the annular member comprises a plug material; the stator further comprising at least one winding void defined between adjacent current-carrying windings; and a rotor disposed in the stator chamber, the rotor comprising a number of rotor disks along a rotor shaft, each rotor disk located along the shaft being adjacent at least one other rotor disk, each rotor disk and adjacent rotor disk defining a space therebetween, the rotor further comprising a sealing layer located in each defined space, wherein each rotor disk comprises at least one magnet adjacent at least one groove wall and defining at least one groove recess therebetween, and wherein each groove recess and each winding void are filled with the plug material.

Various refinements exist of the features noted in relation to the above-mentioned aspects and embodiments. Further features may also be incorporated in the above-mentioned aspects and embodiments as well. These refinements and additional features may exist individually or in any combination. For instance, various features discussed below in relation to any of the illustrated examples may be incorporated into any of the above-described aspects and embodiments, alone or in any combination.

### BRIEF DESCRIPTION OF DRAWINGS

The following drawings form part of the present specification and are included to further demonstrate certain aspects of the present disclosure. The disclosure may be better understood by reference to one or more of these drawings in combination with the detailed description of specific embodiments presented herein.

FIG. 1 shows a perspective view of an electric motor.

FIG. 2 shows an exploded perspective view of the electric motor of FIG. 1.

FIGS. 3A and 3B show exemplary embodiments of a constrained layer damping structure for use in combination with the electric motor of FIG. 2.

FIG. 4 shows a perspective partial cutaway view of the electric motor of FIG. 1.

FIG. 5 is a magnified view of the stator of FIG. 4 illustrating the spaces between the stator windings and motor casing.

FIG. 6 shows a detailed view of a rotor disk shown in FIG. 4.

FIG. 7 shows a perspective view of a rotor assembly consisting of a rotor shaft with rotor disks of FIG. 6 mounted along the shaft.

Corresponding reference characters indicate corresponding parts throughout the several views of the drawings. Although specific features of various examples may be shown in some drawings and not in others, this is for convenience only. Any feature of any drawing may be referenced or claimed in combination with any feature of any other drawing.

### DETAILED DESCRIPTION

The following detailed description and examples set forth preferred materials, components, and procedures used in accordance with the present disclosure. This description and these examples, however, are provided by way of illustration only, and nothing therein shall be deemed to be a limitation upon the overall scope of the present disclosure. The following terms are used in the present disclosure as defined below.

Electric motors are typically made from a variety of different known metals, such as aluminum, steel, or cast iron. However, such electric motors often exhibit operating tendencies where vibrations caused by unbalanced loads, motor component defects, or extreme operating conditions, are amplified by the resonant modes of the structure of the motor. These amplifications are especially evident when low frequency resonant modes are present. Vibratory loads created by unbalanced electromagnetic loads or a significant mechanical load on the electric motor may be particularly prone to amplification in electric motors. Furthermore, vibrational responses are amplified by resonances of the structure, a problem which is particularly evident for low-frequency resonances.

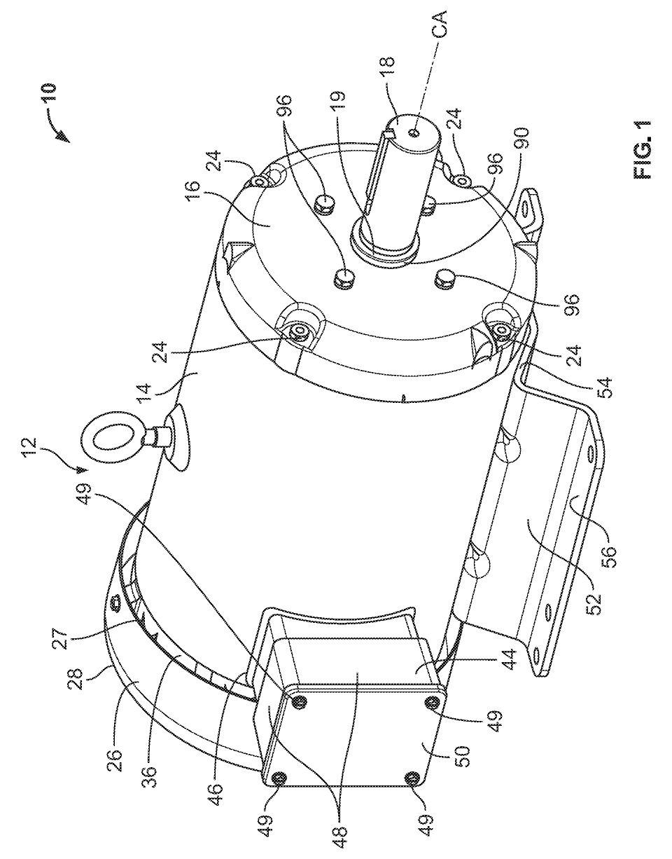

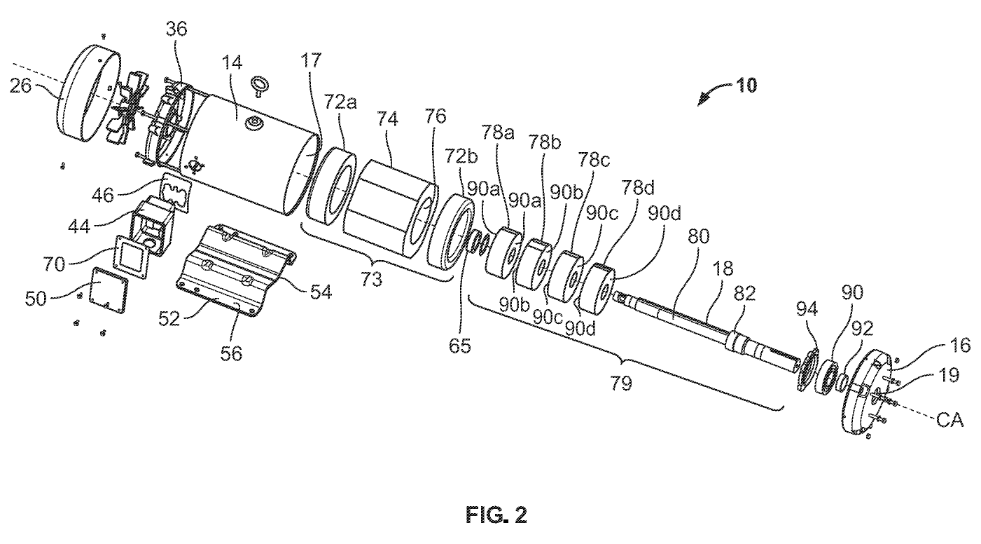

FIGS. 1 and 2 show an electric motor 10 according to some embodiments of the present disclosure. Those skilled in the art will appreciate that significant modifications to the above arrangement are possible while achieving a similar result, and that the present disclosure is not limited to the electric motor arrangement described below.

FIG. 1 shows a perspective view of an improved electric motor 10, according to some embodiments. FIG. 2 shows an exploded assembly view of the motor 10 of FIG. 1. Referring to FIG. 1 and FIG. 2, the motor 10 comprises a casing 12 that has a main casing portion 14. The main casing portion 14 has a wall which forms a hollow cylindrical configuration to define a housing chamber 17. First and second end caps 16 and 36 respectively, close the otherwise open ends of the main casing portion. The first end cap 16 has an opening 19 formed in the end cap 16. When the first end cap is fastened to the main casing portion 14, the opening 19 aligns with central axis CA and enables a portion of a rotor shaft 18 to pass through the opening. The shaft 18 is supported at one end by a first bearing 90 that is attached to an internal face of the first end cap 16 via bearing mounting plate 94 (shown in FIG. 2) using fasteners 96 which are secured to the first end cap 16. A second bearing 65 is similarly mounted to second end cap 36. Threaded fasteners 24 create a secure connection between first end cap 16 and main casing portion 14.

A fan cap 26 is fitted to a cooling end of the main casing portion 14, and when fastened to the casing overlays the second end cap 36 that is fixed to the main casing portion 14. The fan cap has a circular fan cap face 28 which has a diameter that is larger than the diameter of main casing portion 14 and end cap 36. The larger diameter of the circular fan cap 28 relative to the second end cap produces an air gap 27 between fan cap 26 and the second end cap 36. Cooling air is drawn through the rear of the fan cap 26, and is propelled over the outer surface of the main casing portion 14.

An electrical enclosure 44 is mounted along the side of main casing portion 14. Electrical enclosure 44 has a seal plate section 46 for attaching the electrical enclosure to the main casing portion 14. Walls 48 extend from seal plate 46 and define a volume for storing electronic components or electrical connections. An enclosure panel 50 is connected to walls 48 using removable fasteners 49 and serves to cover the volume defined by the walls 48. The enclosure panel 50 is removable for accessing the electronic components within the electrical enclosure 44.

Electric motor 10 is securable to a surface using a mounting bracket 52. Mounting bracket 52 is secured to main casing portion 14. According to some embodiments best shown in FIG. 2, mounting bracket 52 includes a retaining section 54. Retaining section 54 is shaped with a flat central section with two angled sections. The width of the flat central section and the angle of the two angled sections is chosen such as to snugly receive the main casing portion 14. Mounting bracket 52 additionally includes mounting section 56, which includes flanges with holes drilled therethrough for accepting mounting components to secure the electric motor 10 to a surface (not shown) where the motor is located for use.

Referring now to FIG. 2, an exploded perspective view of the electric motor 10 is shown. The previously described casing 12, hollow main casing portion 14 and end caps 16 and 26 are shown. The electric motor also includes a stator 73 that is located in the main casing chamber 17. The stator 73 is comprised of a central stator section 74 and a pair of stator end section 72a, 72b. Each stator end section is positioned at an end of the central stator section.

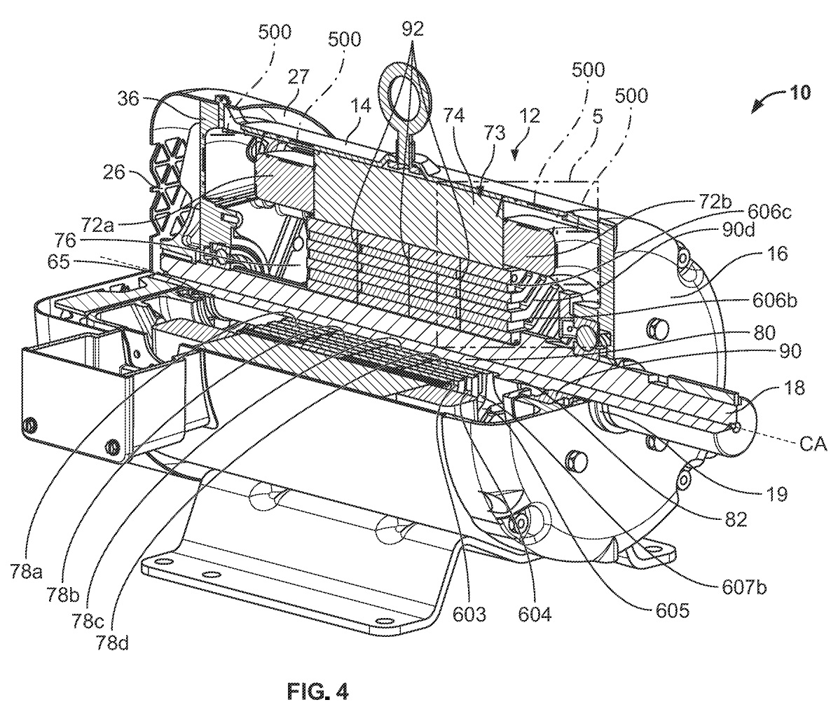

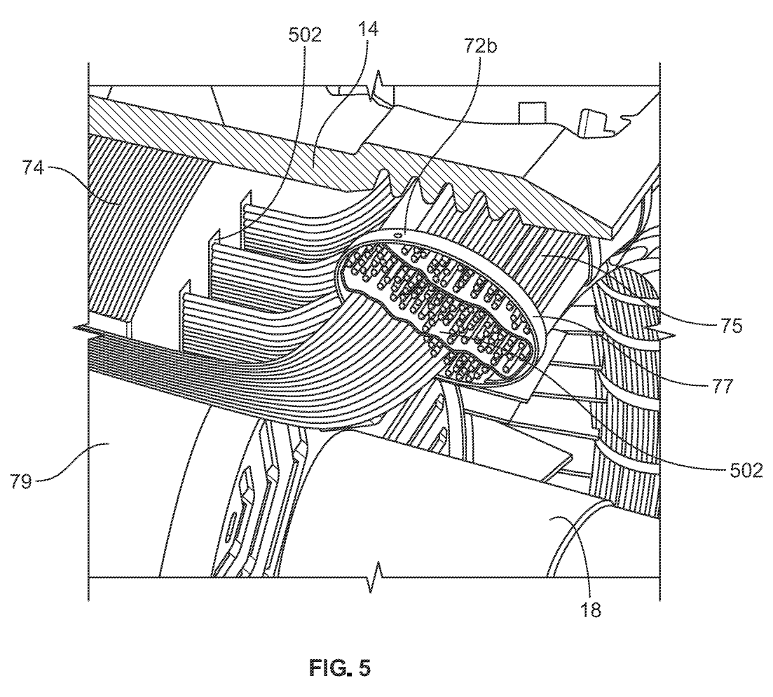

As assembled, the stator end sections 72a, 72b abut each end of a central stator section 74. Stator end sections 72a, 72b are annular members with a diameter which is smaller than that of the main casing chamber 17. As a result, the stator 73 may be located in the chamber 17. When assembled the openings formed in the central section 74 and end sections 72a and 72b are aligned to form a continuous stator chamber 76. The central axis of the chamber 76 is aligned with the central axis CA when the stator is located in the chamber 17. As shown in FIG. 5, stator end sections 72a, 72b comprise a plurality of windings 75, which in some embodiments are enclosed in a case 77. The windings are made of an electrically conductive material which is configured to carry a current. The case 77 may be constructed with metal or a synthetic wrap. Strands of the plurality of windings 75 may additionally be positioned in and/or around central stator section 74 (see FIG. 5). Central stator section 74 comprises a ferromagnetic material which in some embodiments includes slots to hold the plurality of windings 75. The central stator section 74 may be a unitary body (shown in FIG. 4), or may be a plurality of stacked sheets of ferromagnetic material (shown in FIG. 5). Numerous arrangements of windings and electromagnets are possible as known in the prior art. As such, it should be appreciated that alternative arrangements of stator 73 (i.e. with a different number of sections, different section shape or configuration, and/or different arrangements of windings and electromagnets) are possible without departing from the scope of the present disclosure.

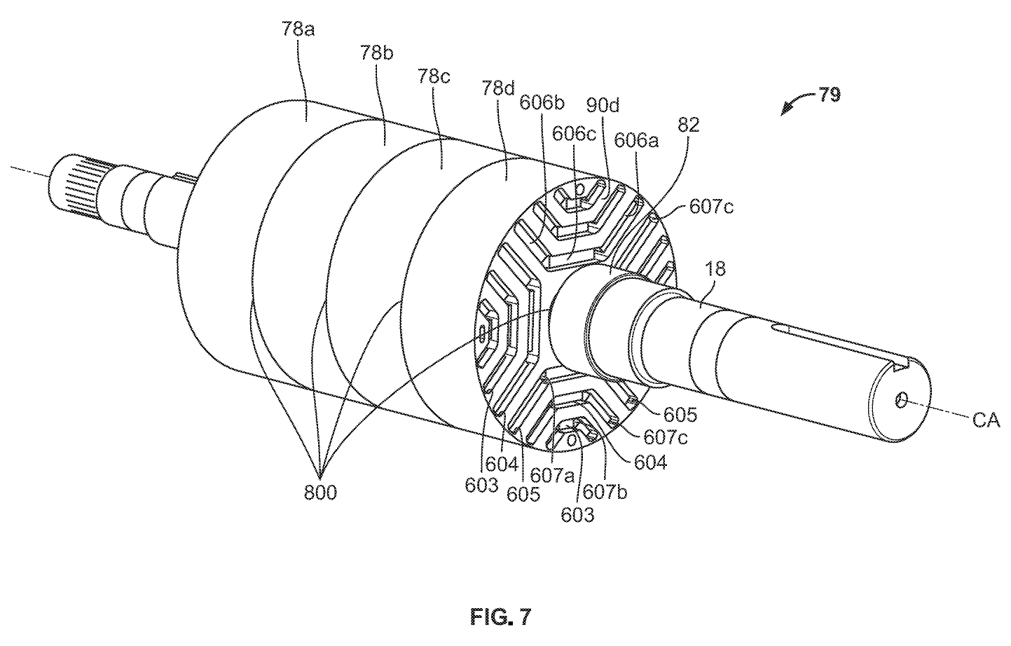

Rotor assembly 79 is shown in FIG. 2. The rotor assembly 79 comprises a plurality of discrete rotor disks 78a, 78b, 78c and 78d (collectively 78a-78d) mounted on rotor shaft 18. As shown, in FIG. 2 and FIG. 4, the rotor assembly of the present disclosure includes four rotor disks, however, motor 10 may include any number of disks depending on the size and torque required to be delivered by the motor 10. Referring to FIG. 7, rotor disks 78a-78d are configured as annular members which are located along a main shaft body 80 of rotor shaft 18. The rotor disk 78d abuts shoulder 82 of rotor shaft 18 to thereby locate the disk 78d in the desired position along the shaft 80. Rotor disk 78c is located adjacent rotor disk 78d along the shaft. Rotor disk 78b is located adjacent rotor disk 78c, and rotor disk 78a is located adjacent disk 78b along rotor shaft 18. As a result, rotor disk 78b is located between rotor disks 78a and 78c, and rotor disk 78c is located between rotor disks 78b and 78d. Each rotor disk 78a, 78b, 78c and 78d is defined longitudinally by opposed faces 90a, 90b, 90c, and 90d respectively (collectively 90a-90d). The faces 90a, 90b, 90cand 90d include similar structure that will be further described herein. Each disk is located proximate each adjacent disk may be separated from adjacent disks by an axial distance or space 92. Spaces 92 are formed between adjacent faces of each pair of adjacent disks. As assembled for use, the rotor assembly 79 is located in the stator chamber 76. See FIG. 4.

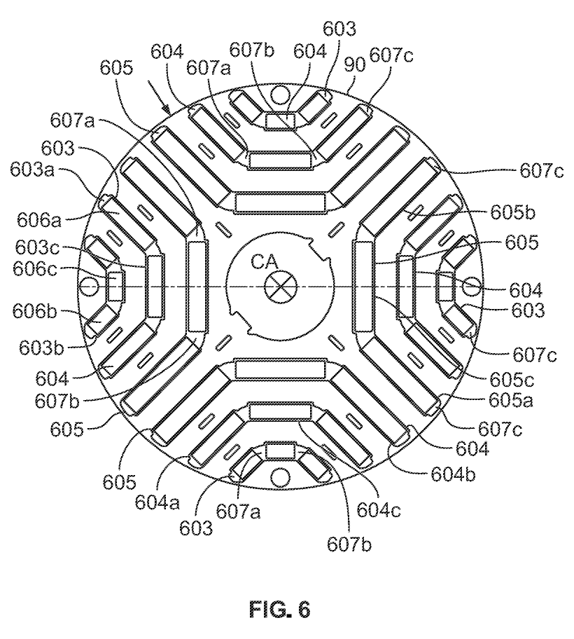

FIG. 6 shows an exemplary face of disk members 78a-78d, identified generally at 90. As the description proceeds the features of face 90 shall be described. It should be understood that the features of face 90 that are described comprise the features associated with the specific opposed faces 90a, 90b, 90c and 90d of respective disks 78a, 78b, 78c, and 78d. For simplicity, face 90 will be referenced. As shown in FIG. 6 each face 90 includes a plurality of U-shaped grooves 603, 604, 605. The grooves are arranged in groups of three, 603, 604, 605, with each adjacent grouping of three grooves offset from the adjacent group of grooves by ninety degrees relative the central axis CA. In each group of grooves, groove 603 includes a pair of groove of opposed groove arms 603a, 603b joined by a groove connector 603c. Groove 604 includes a pair of groove of opposed groove arms 604a, 604b joined by a groove connector 604c and Groove 605 includes a pair of opposed groove arms 605a, 605b joined by groove connector 605c. For each grouping of grooves, the magnitude of the dimensions of the arms and connector for grooves are at a maximum for groove 605 of each groove grouping. The magnitude of the dimensions of the arms and connector are at a minimum for groove 603 of each groove grouping, and the magnitude of the dimensions of the arms and connector for groove 604 of each groove grouping at a magnitude value between the magnitudes of similar arms and connectors of grooves 603 and 605.

Each groove arm and groove connector of each groove 603, 604 and 605 of each groove grouping is adapted to receive at least one magnet 606. A magnet 606 is located in each arm and connector of each groove 603, 604 and 605 of each groove grouping. Each magnet 606 has a length that is substantially equal to the length of the arm or connector where the magnet is located. The magnets located in the arms have reference numbers 606a and 606b and the magnets located in the connectors are identified as 606c in FIG. 6. The magnets 606a, 606b, 606c may be electromagnets or permanent magnets. As shown in FIG. 6, when the magnets are located in the respective portions of the grooves 603, 604, 605, groove recesses 607a, 607b are defined between the ends of connector magnets 606c and the ends of arm magnets 606a and 606b adjacent the connector magnet ends. Additionally, groove recesses 607c are defined between the opposite ends of the arm magnets 606a, 606b and the closed ends of the arm grooves.

The casing 12 can serve as a means for amplifying vibrations in prior art electric motors. Therefore, in order to limit the amplification of motor vibrations the main casing portion 14 of the electric motor 10 may be made from a constrained layer damping structure. As used herein, the term constrained layer damping structures shall be defined to include structures that significantly damp or overdamp natural frequencies of a structure to which the constrained layer damping structures are applied. The casing may be made entirely or substantially from the constrained layer damping structures. Additionally, discrete components of casing 12 may be made entirely or substantially from the constrained layer damping structures. Additionally, the constrained layer damping structure may be applied to a surface of the casing and/or discrete components of casing 12. The constrained layer damping structure could be used to construct first end cap 16, second end cap 36, or main casing portion 14. Generally, the constrained layer damping structure comprises a high-loss (i.e. viscoelastic) material within a solid construction, and as the construction vibrates, the mechanical energy of the vibrations is converted to other forms via deformation of the high-loss material. Constrained layer damping structures can inhibit resonances over a wide range of frequencies, although performance at medium and high frequencies is typically more pronounced.

Using a constrained layer damping structure for any of the three components reduces the vibrational tendencies of that particular component, therefore reducing the likelihood of resonant vibratory modes. In particular, the constrained layer damping structure damps or inhibits vibrations in a component made from, or including the constrained layer damping structure. When a component that vibrates during motor use includes the constrained layer damping structure, the vibrational tendencies of the associated component are measurably reduced relative to the vibrational tendencies of the equivalent structure component made solely of metal or more generally a material that is not a constrained layer damping structure. Because the constrained layer damping structure as designed damps vibration of an attached structure, the likelihood of resonance and/or vibration transmission is reduced. In some exemplary embodiments, if the main casing portion 14 is constructed using the constrained layer damping structure, then any vibrations originating from components proximate to the main casing portion 14 are minimized. Such vibrations may be produced by the stator 73 or rotor 79 for example. The vibrations are damped before the vibrations can be transmitted from the casing to other motor components. such as the end caps 16, 36 or mounting bracket 52. In some exemplary embodiments, if first end cap 16 and second end cap 36 are constructed of the constrained layer damping structure, vibrations originating in or passed through the rotor 79 and transferred through the bearings 90, 65 to the end caps 16, 36 are damped in the end caps 16, 36. Any vibrations transmitted through the end caps to main casing portion 14 and mounting bracket 52 are significantly reduced, thus reducing the likelihood of disruptive resonant modes. Using a damped mounting bracket 52 decouples vibrations between the electric motor 10 and a mounting surface Using the constrained layer damping structure to construct any components of the casing 12 generally reduces the likelihood and/or amplitude of transmitted vibrations, thus reducing unwanted noise, extending product life, and reducing the risk of catastrophic failure which could partially be caused by vibrations. Components of casing 12 may be constructed entirely of the constrained layer damping structure, or the constrained layer damping structure or elements thereof may be adhered to one or more of the components as a discrete structure. The constrained layer damping structure may be used to build a component during manufacturing, or it may be applied to a component during a retrofit process. The components of casing 12 may also have a mixed construction of both the constrained layer damping structure and a metal.

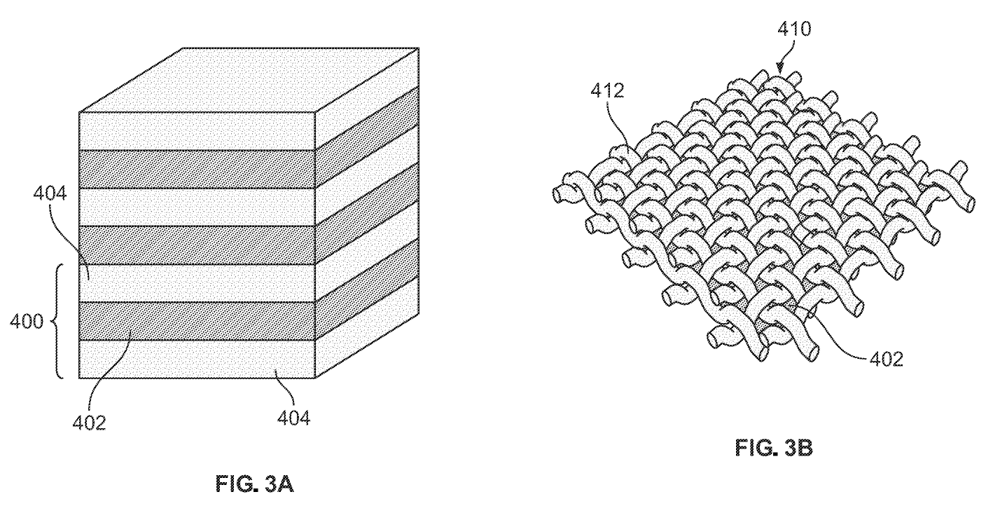

Two embodiments of the constrained layer damping structure are shown in FIG. 3A and FIG. 3B. FIGS. 3A and 3B show magnified exemplary embodiments of the constrained layer damping structure. In the exemplary embodiment constrained layer damping structure 400 of FIG. 3A, the constrained layer damping structure 400 is constructed of alternating layers or sheets of high-loss material 402 and a solid material 404. In some embodiments, the solid material 404 consists of a metal, such as a sheet of aluminum or steel. However, other materials known in the art with similar stiffness and/or strength may be used. It is desirable for the high loss material 402 to exhibit high elasticity, high viscosity, and/or other damping characteristics. In some embodiments, the high loss material may be a plasticine, elastomer, bituminous material, or another material with similar mechanical properties. In some embodiments, the high loss material is an elastomer. Generally, the high loss material may exhibit significant viscoelastic effects.

The structure 400 may be comprised of any suitable number of alternating solid layers 404 and high-loss layers 402. The constrained layer structure 400 should include at least two layers of solid material 402 with a layer of high-loss material 404 between the two solid layers. Those skilled in the art will appreciate that any number of layers of either the high-loss material 402 and/or solid material 404 may be used, as additionally shown in FIG. 3A. For example, it may be desirable to use additional layers for a component which has a fastener embedded therein to add structural stability. Generally, the layer thicknesses and combination are dependent on the specific associated component, vibrations associated with the component and the motor application. Typically, the outermost layers of the structure 400 will consist of solid material 404 to ensure the structural integrity of the component, and also to ensure the effective transfer of shear and vibrational forces which lead to energy absorption in the high-loss material. When the constrained layer damping structure is retrofitted to the outside of an existing casing 12, part or all of the casing 12 (e.g. first end cap 16, second end cap 36, and/or main casing portion 14) may act as the innermost layer of solid material 404. Alternatively, the constrained layer damping structure may be retrofitted to the inside of an existing casing 12, in which case part or all of the casing 12 (e.g. first end cap 16, second end cap 36, and/or main casing portion 14) may act as the outermost layer of solid material 404.

Constrained layer damping structure designs can vary widely. Inner and outer layers need not have the same thickness. For motor applications, layer thicknesses can vary from small fractions of a millimeter to several centimeters, and layer thickness ratios can range from 1:1 to 100:1. Natural frequencies and their associated damping factors are dictated by the thickness, density, elasticity, and viscoelasticity of the materials, the geometrical size of the structure, and the kinematic constraints on structural motions. Natural frequencies may be sufficiently damped or overdamped so the structure is not prone to resonant excitations.

The high-loss material 402 is secured to solid material 404 or a lattice material 412 using an adhesive. It is desirable for the adhesive to exhibit elastic properties such as viscoelastic properties. Alternatively, the high-loss material 402 may itself have adhesive characteristics, enabling the direct adhesion between layers 402 and 404. In some cases, the constrained layer damping structure itself may be adhered to an existing component surface using a glue or similar adhesive.

A second exemplary embodiment of constrained layer damping structure 410 is shown in FIG. 3B. Constrained layer damping structure 410 is constructed by impregnating the lattice or webbing material 412 with the high-loss material 402. The high-loss material 402 has the same or similar properties as high-loss material described in use in the exemplary embodiment shown in FIG. 3A and as previously described. The damping structure may comprise a single row lattice as shown in FIG. 3B or a plurality of interconnected lattice rows. The structure 410 and associated lattice 412 may be substantially planar comprising a fiberglass mat or cloth. Alternatively, the lattice may have a measurable thickness where the structure 410 may be a metal lattice created using additive manufacturing. However, those skilled in the art will appreciate that numerous materials and manufacturing techniques exist to create a lattice which has the dimensional features required to absorb the expected vibrations when motor 10 is in use. When manufacturing structure 410, typically, the lattice 412 is constructed first, and the high loss material 402 is injected, inserted, or placed into the lattice interstitial gaps, defined by the crossing lattice members 412. An example embodiment of this structure is shown in FIG. 3B and those skilled in the art will appreciate that other arrangements of interstitial gaps are possible depending on the arrangement of lattice 412.

In use, the structure 410 may comprise a fiberglass cloth that is fitted around the main casing portion 14. The structure 410 may be constructed using a twill weave process. A binder known in the art is used to hold the fiberglass cloth weave together, but the high-loss material 402 may be additionally injected with the binder to add a damping layer within the weave, thus creating a constrained layer damping structure. The constrained layer damping structure is then adhered to the main casing portion 14 using an adhesive or other means previously described.

Alternatively, the structure 410 may comprise 3D lattice containing a plurality of interstitial voids that may be manufactured using an additive manufacturing process such as material jetting. The interstitial voids that are produced are then filled with the high-loss material 402 via injection. When vibrations are transmitted into the 3D lattice, the vibrations are additionally transmitted into the interstitial high-loss material, which converts the mechanical energy of the vibrations into other forms of energy (e.g. heat) through axial and/or shear deformation.

In some embodiments, the structure 410 may be a wire-mesh screen, fibrous cloth (e.g. fiberglass), or layers thereof, which may be formed to the desired shape. The structure 410 may be pre- or post-impregnated with uncured viscoelastic material, which may be subsequently heated to cure the material.

The chosen material for the solid material 404 and/or lattice 412 may desirably be designed such as to attenuate vibration at low, medium, and/or high frequencies. As a result, the material chosen for the main casing portion 14 may be different from the material chosen for the cap ends or mounting bracket. Similarly, the mechanical needs for each component are different, thus making different structures desirable. For example, the first end cap 16 experiences radial loading resulting from the rotor. Therefore, using a 3-D lattice constrained damping material 410 may be desirable over a layered constrained damping material 400, due to the lattice being easier to shape into the desired first end cap 16 shape while also being able to better withstand the radial loading in said shape. Alternatively, the constrained layer damping structure may be applied to a surface of the first end cap 16, with the first end cap being made of metal such that the surface of the first end cap acts as either the innermost or outermost layer of solid material 404.

In some embodiments, parts which traditionally may be made of stamped metal (e.g. the fan cap 26, first end cap 16, second end cap 36, main casing portion 14, and/or mounting bracket 52) may instead be made with a constrained layer damping structure consisting of a high-loss (e.g. viscoelastic) layer sandwiched between two layers of solid (e.g. metal) material.

In some embodiments, tapes made of the constrained layer damping structure may be wrapped around motor parts (e.g. the fan cap 26, first end cap 16, second end cap 36, and/or main casing portion 14). In some embodiments, the tapes may be wrapped around the motor shaft to damp torsional vibrations.

Referring now to FIG. 4, a cutaway perspective view of the electric motor 10 is shown. Relatively large volume voids 500 between the stator and casing can be filled with either the constrained layer damping structure or a plug material (described in detail below) to reduce vibrations within the casing 12. These large voids typically have a width ranging from less than 1 cm to 5 cm or larger, but the size is largely dependent on the size of the motor 10. Additionally, interstitial winding voids 502 defined between individual stator windings and/or between windings and proximate surfaces shown in FIG. 5, may be filled with the plug material. Plugging winding voids 502, large voids 500, or other voids within the casing 12 reduces the independent vibration of each component adjacent the void. In some embodiments, voids are intentionally placed between components (e.g. between windings) specifically so that the plug material can be inserted. For example, filling the large voids 500 shown in FIG. 4 would limit the ability of the stator 73 to freely vibrate within the main casing portion 14. Since the materials used to plug the large voids 500 provide damping, vibrations are attenuated. Furthermore, when the large gaps 500 and voids 502 are plugged, the vibrations of the stator 73 are limited by the plugging material.

Typically, the plug material of choice is able to operate effectively in environments of higher than 100 degrees Celsius and, in some embodiments, may possess electrical insulating properties. The plug material is a viscoelastic material which absorbs energy when the surfaces adjacent to the respective void vibrate and cause the viscoelastic material to deform. In some embodiments, a filled elastomer is adequate for use as the plug material. In some embodiments, HDPE is adequate for use as the plug material. Those skilled in the art will appreciate that other materials with similar material properties may be used for the plug material.

For small voids such as the winding voids 502, the plug material may be injected into the voids during assembly of the motor 10 or as part of a retrofit procedure. For large voids, the plug material may be pre-formed (e.g. via a heat setting procedure) prior to installation within the electric motor 10. Those skilled in the art will appreciate that manufacturing processes which result in similar arrangements of the plug material may also be used without departing from the scope of the present disclosure.

Referring now to FIG. 6, each of the groove recesses 607a, 607b and 607c in the disks 78a, 78b, 78c and 78d are filled with the plug material previously described. By locating the plug material in the groove recesses, propagation of vibrations in the rotor disks is minimized. Additionally, if the plug material has adhesive properties, it can be used as a glue which holds each respective magnet 606a, 606b, 606c within each respective groove 603, 604, 605. In some embodiments, the plug material is added with a wick and allowed to cure.

Referring now to FIG. 7, the assembled rotor 79 is shown in a perspective cutaway view. The plurality of rotor disks 78a-78d are positioned along the main shaft body 80 of the rotor shaft 18. Each rotor disk 78a-78d is positioned co-axially with central axis CA. Each adjacent pair of rotor disks is positioned with a sealing layer 800 therebetween. In some embodiments, sealing layer 800 is positioned to fill spaces 92 between adjacent disks. In some embodiments, spaces 92 are intentionally added between rotor disks 78a-78d such that sealing layer 800 may be inserted. The sealing layer 800 may be applied to a single disk face 90, so that when the adjacent disks are located on the shaft 18, the sealing layer 800 is located between the disks. Alternatively, the sealing layer 800 may be applied along faces 90 of adjacent disks and compressed between the disks when the disks are mounted along the shaft 18. In embodiments where the rotor 79 includes a single disk, the sealing layer may purely be placed between the shoulder 82 and the respective disk, or omitted entirely in favor of other damping structures described herein.

In some embodiments, the sealing layer 800 is comprised of a damping potting material such as a silicone rubber gel. The damping potting material is either applied directly to at least one face of each rotor disk 78a-78d or may comprise an annular configuration formed along a portion of a face 90. The rotor disks 78a-78d are pushed into adjacent contact along the main shaft body 80 such that the damping potting material is maintained between adjacent disks. The damping potting material may also comprise a discrete disk-shaped member that is separately positioned on the shaft as the rotor is assembled and then compressed between adjacent disks.

In some embodiments, the sealing layer 800 comprises a fibrous lattice or layer construction which can be impregnated or otherwise combined with another material such as the high loss material used in the constrained damping layer described herein. The impregnation material may also comprise the damping potting material previously described. In some embodiments, the impregnated fibrous layer and the impregnation material are combined to create sealing layer 800. In an exemplary embodiment, the sealing layer 800 is constructed with a fibrous layer impregnated with an elastomer, then a silicone gel is applied to the outer surface of the fibrous layer.

The sealing layer 800 decouples vibrations between adjacent rotor disks 78a-78d. The sealing layer may also be positioned between the forward most rotor disk 78d and the shaft shoulder 82 to provide a damping buffer between the rotor disk 78d and the rotor shaft 18.

As described above, the damping potting material can be a silicon rubber gel. In other embodiments, the damping potting material may be a thermosetting plastic with a high elasticity, a resin with a high viscosity and/or elasticity, or an elastomer. The fibrous lattice or layer may be fiberglass, carbon fiber, layer aluminum or steel, or a woven plastic. The impregnation material may be the damping potting material as described above, or it may be selected from the materials discussed in relation to the high loss material described above. Those skilled in the art will appreciate that other materials which have similar material properties may be used for the damping potting material, fibrous layer, or impregnation material.

As described, the motor 10 effectively impedes and damps the transmission of vibration during motor use. Vibration may be impeded by the use of constrained layer damping materials. The motor casing 12 may include or be made from a constrained layer damping material. The main casing portion 14 and/or casing end caps 16, 36 may include, or be made from, a constrained layer damping structure. Plugging material may be included in voids in the motor to additionally limit motor vibration. The plugging material may be located in groove recesses between magnets located in grooves formed along the disk faces. The plugging material may also be placed in voids and recesses formed between the stator 73 and casing 12 and between stator windings. A sealing layer may be placed between adjacent rotor disks 78a-78d. The plugging material, sealing layer, and constrained layer damping material may be used in combination or singly to provide effective motor damping.

Embodiments of the present disclosure provide for an electric motor with a number of advantages over the prior art. In particular, a motor body consisting either partially or entirely of a constrained layer damping structure is provided, which damps vibration in the motor body. Furthermore, a plug material for filling a variety of voids within the electric motor is provided. The plug material fills medium or large gaps in the motor construction to provide damping between vibrational sources and/or other components. A sealing layer for a stacked rotor construction is provided which damps vibrations between each rotor disk.

As used herein, an element or step recited in the singular and proceeded with the word “a” or “an” should be understood as not excluding plural elements or steps unless such exclusion is explicitly recited. Furthermore, references to “one embodiment” of the disclosure or an “exemplary” or “example” embodiment are not intended to be interpreted as excluding the existence of additional embodiments that also incorporate the recited features. Likewise, limitations associated with “one embodiment” or “an embodiment” should not be interpreted as limiting to all embodiments unless explicitly recited.

Disjunctive language such as the phrase “at least one of X, Y, or Z,” unless specifically stated otherwise, is generally intended, within the context presented, to disclose that an item, term, etc. may be either X, Y, or Z, or any combination thereof (e.g., X, Y, and/or Z). Likewise, conjunctive language such as the phrase “at least one of X, Y, and Z,” unless specifically stated otherwise, is generally intended, within the context presented, to disclose at least one of X, at least one of Y, and at least one of Z.

The disclosed systems and methods are not limited to the specific embodiments described herein. Rather, components of the systems or steps of the methods may be utilized independently and separately from other described components or steps.

This written description uses examples to disclose various embodiments, which include the best mode, to enable any person skilled in the art to practice those embodiments, including making and using any devices or systems and performing any incorporated methods. The patentable scope is defined by the claims and may include other examples that occur to those skilled in the art. Such other examples are intended to be within the scope of the claims if they have structural elements that do not differ from the literal language of the claims, or if they include equivalent structural elements with insubstantial differences from the literal language of the claims.

We claim:

1. An electric motor comprising:
a casing defining a casing chamber, the casing comprising a constrained layer damping structure;
at least one casing end cap which is affixed to an end of the casing chamber, the at least one end cap comprising a constrained layer damping structure;
a stator disposed within the casing chamber, the stator comprising an annular structure which defines a stator chamber, the annular structure comprising a plurality of current-carrying windings; and
a rotor disposed in the stator chamber, the rotor comprising a number of rotor disks along a rotor shaft.

2. The electric motor of claim 1, wherein the constrained layer damping structure comprises a layer of high-loss material that is located between metal sheets.

3. The electric motor of claim 1 wherein the constrained layer damping structure comprises a plurality of layers of high-loss material, each layer of the plurality of high-loss material being located between metal sheets.

4. The electric motor of claim 1, wherein the constrained layer damping structure comprises a woven fiber or lattice construction which is impregnated with a high-loss material.

5. The electric motor of claim 1, wherein the constrained layer damping structure comprises a high-loss material that further comprises an elastomer.

6. The electric motor of claim 1, wherein the sealing layer comprises a damping potting material.

7. The electric motor of claim 1, wherein the sealing layer comprises a combination of pregnable fibrous layers and damping potting material.

8. The electric motor of claim 1, wherein the sealing layer comprises fibrous layers pre-impregnated with damping potting material.

9. The electric motor of claim 1, wherein the constrained layer damping structure comprises a layer of high loss material that is located between metal sheets, and wherein a thickness ratio between the high loss material and the metal sheets is between 1:1 and 100:1.

10. The electric motor of claim 1, wherein the stator comprises at least one winding void defined between adjacent current-carrying windings and the rotor comprises at least one magnet proximate at least one groove wall and defining at least one groove recess therebetween, and wherein the at least one winding void and at least one groove recess are filled with a plug material.

11. The electric motor of claim 1 wherein the constrained layer damping material is comprised of a layer located on the casing, and a separate layer located on at least one of the at least one end cap.

12. The electric motor of claim 1, wherein the casing and at least one end cap are made from a constrained layer damping material.

13. The electric motor of claim 1, wherein the annular structure of the stator and the casing chamber define a gap therebetween, wherein the gap is filled with an annular member which is co-axial with the stator chamber, and wherein the annular member comprises a plug material.

14. An electric motor comprising:
a stator comprising a plurality of current-carrying windings;
a rotor disposed proximate the stator, the rotor comprising at least two rotor disks mounted on a rotor shaft, each of the at least two rotor disks being adjacent at least one rotor disk, adjacent rotor disks defining a space, wherein a sealing layer is located in each space defined by adjacent disks, and wherein each of the at least two rotor disks comprising at least one magnet positioned adjacent at least one groove wall and defining at least one groove recess therebetween.

15. The electric motor of claim 14, wherein the sealing layer comprises a sealing layer material selected from the group consisting of damping potting material; a combination of pregnable fibrous layers and damping potting material; fibrous layers pre-impregnated with a damping potting material; and a combination of damping potting material and fibrous layers pre-impregnated with damping potting material.

16. The electric motor of claim 14, wherein the stator comprises at least one winding void defined by adjacent current-carrying windings, and the rotor comprises at least one groove recess, and wherein the at least one groove recess and at least one winding void are filled with a plug material.

17. The electric motor of claim 16, wherein the plug material is a filled elastomer.

18. The damped frequency electric motor of claim 14, wherein the rotor and stator are at least partially located in a casing made substantially from a constrained layer damping structure, the constrained layer damping structure comprising a high-loss material that further comprises an elastomer.

19. The electric motor of claim 18, wherein the constrained layer damping structure comprises one of either:
a stacked construction, wherein the high-loss material is placed between metal sheets, or
a woven fiber or lattice construction, wherein the woven fiber or lattice construction is impregnated with a high-loss material.

20. An electric motor comprising:
a casing defining a casing chamber, the casing comprising a constrained layer damping structure;
at least one casing end cap which is affixed to an end of the casing chamber, the at least one end cap comprising a constrained layer damping structure;
a stator disposed within the casing chamber, the stator comprising an annular structure which defines a stator chamber, the annular structure comprising a plurality of current-carrying windings, wherein the annular structure of the stator and the casing chamber define a gap therebetween, wherein the gap is filled with an annular member which is co-axial with the stator chamber, and wherein the annular member comprises a plug material;
the stator further comprising at least one winding void defined between adjacent current-carrying windings; and
a rotor disposed in the stator chamber, the rotor comprising a number of rotor disks along a rotor shaft, each rotor disk located along the shaft being adjacent at least one other rotor disk, each rotor disk and adjacent rotor disk defining a space therebetween, the rotor further comprising a sealing layer located in each defined space,
wherein each rotor disk comprises at least one magnet adjacent at least one groove wall and defining at least one groove recess therebetween, and
wherein each groove recess and each winding void are filled with the plug material.
